(19) United States
(12) Patent Application Publication
(10) Pub. No.: US 2016/0024375 A1
(43) Pub. Date: Jan. 28, 2016

(54) Friction Reducing Polymers

(71) Applicants: Jiang LI, (US); Ronald SON, Newnan, GA (US); Philip WATSON, Kennesaw, GA (US); Logan JACKSON, Norcross, GA (US); Kemira Oyj, Helsinki (FI)

(72) Inventors: Jiang Li, Johns Creek, GA (US); Ronald Robinson, Newnan, GA (US); Philip Watson, Kennesaw, GA (US); Logan Jackson, Norcross, GA (US)

(73) Assignee: Kemira Oyj, Helsinki (FI)

(21) Appl. No.: 14/774,438

(22) PCT Filed: Mar. 18, 2014
(86) PCT No.: PCT/US14/30950

§ 371 Date: Sep. 10, 2015

Related U.S. Application Data
(60) Provisional application No. 61/790,578, filed on Mar. 15, 2013.

(51) Int. Cl. C09K 8/68; E21B 43/20; E21B 43/26

(52) U.S. Cl. CPC C09K 8/68; E21B 43/26; E21B 43/20; C09K 2208/28

(57) ABSTRACT

Described herein are friction reducing polymers comprising two or more recurring units wherein at least one recurring unit is an acrylic acid or acrylamide monomer and at least one recurring unit is a vinyl monomer selected from a vinyl alcohol, a vinyl ester, and a vinyl ether.

### CROSS REFERENCE TO RELATED APPLICATIONS

This application claims the benefit of U.S. Provisional Application No. 61/790,578, filed on Mar. 15, 2013, which is incorporated herein by reference in its entirety.

### FIELD OF THE ART

The disclosure is in the field of friction reducing polymers and their use in treating subterranean formations and sea water injection applications.

### BACKGROUND

In the drilling, completion, and stimulation of oil and gas wells, well treatment fluids are often pumped into well bore holes under high pressure and at high flow rates. As the fluid is pumped through the system at high flow rates (thousands of GPM) there is a significant amount of frictional resistance, which results in large energy requirements.

In order to reduce the friction between the well treatment fluid and the bore linings, friction pressure reducing additives have been combined with the treatment fluids and added during pumping so as to reduce pump pressure. For example, a type of well treatment commonly utilized for stimulating hydrocarbon production from a subterranean zone penetrated by a well bore is hydraulic fracturing. Hydraulic fracturing, also referred to as fracing (or fracking), is used to initiate production in low-permeability reservoirs and re-stimulate production in older producing wells. In hydraulic fracing, a fluid composition is injected into the well at pressures effective to cause fractures in the surrounding rock formation. Fracing is used both to open up fractures already present in the formation and create new fractures.

Water soluble polymers can be used as friction reducers in well treatment fluids to reduce the turbulent flow, and lower the energy loss in the fluid due to friction as the fluid is pumped through the system. These types of treatments are often called “slick water treatments or slick water fracs.” Conventional polyacrylamide polymers provide efficient friction reduction.

### BRIEF SUMMARY

Described herein is a friction reducing polymer comprising two or more recurring units wherein at least one recurring unit is an acrylic acid or acrylamide monomer and at least one recurring unit is a vinyl monomer selected from a vinyl alcohol, a vinyl ester, and a vinyl ether. Well treatment fluids comprising the polymers, as well as methods for reducing friction losses in a well treatment fluid and methods of treating a subterranean formation, for example in hydraulic fracturing and sea water injection applications, are also provided.

The disclosure may be understood more readily by reference to the following detailed description of the various features of the disclosure and the examples included therein.

### DETAILED DESCRIPTION

Disclosed herein are friction reducing polymers comprising recurring units of i) acrylic acid or acrylamide monomers and ii) vinyl monomers selected from vinyl esters, vinyl alcohols, and vinyl ethers, including hydrolyzed derivatives thereof. Exemplary polymers can be used to provide reduction of friction-related energy losses in hydraulic fracturing applications. The polymers include a significant fraction of reactive groups which can be readily modified. The polymers can be minimally- or substantially-derivatized with various functional groups to modify the physical properties as desired.

As used herein, the terms “polymer,” “polymers,” “polymeric,” and similar terms are used in their ordinary sense as understood by one skilled in the art, and thus may be used herein to refer to or describe a large molecule (or group of such molecules) that contains recurring units. Polymers may be formed in various ways, including by polymerizing monomers and/or by chemically modifying one or more recurring units of a precursor polymer. A polymer may be a “copolymer” comprising two or more different recurring units formed by, e.g., copolymerizing two or more different monomers, and/or by chemically modifying one or more recurring units of a precursor polymer.

In exemplary embodiments, the polymers can be used to reduce energy loss due to friction such as between an aqueous fluid in turbulent flow and tubular goods, e.g. pipes, coiled tubing, and the like, and/or formation. In exemplary embodiments, the polymers can be added to slick water treatments at concentrations of about 0.1 to about 5 gallons per 1000 gallons, or about 0.25 to about 2.5 gallons per 1000 gallons, of stimulation fluid. In exemplary embodiments, the polymers may be anionic, cationic, amphoteric or non-ionic depending on desired application. In exemplary embodiments, the polymers may include hydrophilic moieties, hydrophobic moieties, or combination thereof.

In exemplary embodiments, a friction reducing polymer comprises two or more recurring units wherein at least one recurring unit is an acrylic acid or acrylamide monomer and at least one recurring unit is a vinyl monomer selected from a vinyl alcohol, a vinyl ester, and a vinyl ether monomer.

In exemplary embodiments, the acrylic acid or acrylamide monomer is selected from acrylic acid and substituted acrylic acids, for example, methacrylic acid. In exemplary embodiments, the acrylic acid or acrylamide monomer is selected from acrylamide and substituted acrylamides, for example methacrylamide, N-methylol acrylamide, N,N-dimethylacrylamide, 2-acrylamido-2-methylpropane sulfonic acid; and the like.

In exemplary embodiments, the vinyl monomer is a vinyl alcohol. In exemplary embodiments, the vinyl monomer is a vinyl ester, for example vinyl acetate, vinyl propionate, vinyl butanoate, vinyl pentanoate, vinyl hexanoate, vinyl ester of versatic acid, and the like. In exemplary embodiments, the vinyl monomer is a vinyl ether, for example, vinyl methyl ether, vinyl ether ethyl, vinyl propyl ether, and the like.

In exemplary embodiments, the polymer is fully hydrolyzed. In exemplary embodiments, the polymer is partially hydrolyzed. In exemplary embodiments, the vinyl esters of the polymer are partially or fully hydrolyzed to vinyl alcohol. Those of ordinary skill in the art, with the benefit of this disclosure, will recognize an appropriate hydrolysis method to hydrolyze the polymer to the desired extent of hydrolysis.

In exemplary embodiments, the hydrolysis reaction is base catalyzed. In particular embodiments, the base is a strong base, e.g., metal hydroxides (Ca, Li, Na, K, Rb, Cs, Sr, etc.). In a particular embodiment, the polymer is hydrolyzed by sodium hydroxide. In other embodiments, the hydrolysis reaction is acid catalyzed. In particular embodiments, the acid is a strong acid, e.g., sulfuric acid, hydrochloric acid, nitric acid, sulfuric acid, hydrobromic acid, perchloric acid.

In exemplary embodiments, the polymer comprises about 1% to about 90%, about 1% to about 80%, about 1% to about 70%, about 1% to about 60%, about 1% to about 50%, about 1% to about 40%, about 1% to about 30%, or about 1% to about 20% vinyl monomers by weight. In exemplary embodiments, the polymer comprises less than about 90%, about 80%, about 70%, about 60%, about 50%, about 40%, about 30%, about 20%, about 15%, about 10%, or about 5% vinyl monomers by weight.

In exemplary embodiments, the polymer comprises about 10% to about 99%, 20% to about 99%, 30% to about 99%, 40% to about 99%, 50% to about 99%, 60% to about 99%, 70% to about 99%, or 80% to about 95% acrylic acid and/or acrylamide monomers by weight. In exemplary embodiments, the polymer comprises at least about 90%, about 80%, about 70%, about 60%, about 50%, about 40%, about 30%, or about 20% acrylic acid and/or acrylamide monomers by weight.

In exemplary embodiments, the polymer comprises about 1% to about 90%, about 1% to about 80%, about 1% to about 70%, about 1% to about 60%, about 1% to about 50%, about 1% to about 40%, about 1% to about 30%, or about 1% to about 20% vinyl monomers by mole. In exemplary embodiments, the polymer comprises less than about 90%, about 80%, about 70%, about 60%, about 50%, about 40%, about 30%, about 20%, about 15%, about 10%, or about 5% vinyl monomers by mole.

In exemplary embodiments, the polymer comprises about 10% to about 99%, 20% to about 99%, 30% to about 99%, 40% to about 99%, 50% to about 99%, 60% to about 99%, 70% to about 99%, or 80% to about 95% acrylic acid and/or acrylamide monomers by mole. In exemplary embodiments, the polymer comprises at least about 90%, about 80%, about 70%, about 60%, about 50%, about 40%, about 30%, or about 20% acrylic acid and/or acrylamide monomers by mole.

In exemplary embodiments, the polymer is an anionic polymer. In a particular embodiment, the anionic polymer has about 1% to about 50% charge, about 1% to about 45% charge, about 5% to about 40% charge, or about 5% to about 35% charge.

In exemplary embodiments, the polymer is a cationic polymer. In a particular embodiment, the cationic polymer has about 10% to about 50% charge.

In exemplary embodiments, the polymer is an amphoteric polymer. In exemplary embodiments, the polymer is a non-ionic polymer.

In exemplary embodiments, the polymers are of a molecular weight sufficient to provide a desired level of friction reduction. In exemplary embodiments, the weight average molecular weight of the polymers may be in the range of from about 1,000,000 to about 30,000,000; about 7,500,000 to about 30,000,000; or about 10,000,000 to about 30,000,000 Dalton, as determined using intrinsic viscosities. Those of ordinary skill in the art will recognize that friction reducing polymers having molecular weights outside the listed range may still provide some degree of friction reduction in the treatment fluid.

Exemplary friction reducing polymers may be in an acid form or in a salt form. A variety of salts may be made by neutralizing the acid form of certain monomers with a base, such as sodium hydroxide, ammonium hydroxide or the like. As used herein, the term “polymer” is intended to include both the acid form of the friction reducing copolymer and its various salts.

In certain embodiments, the polymer is linear. In other embodiments, the polymer structure may include branched polymers, star polymers, comb polymers, crosslinked, slightly crosslinked, and hyper-branched polymers.

In exemplary embodiments, the polymer may be made in accordance with any of a variety of polymerization methods. For example, suitable methods of addition polymerization include but are not restricted to free radical polymerization, controlled radical polymerization such as atom transfer radical polymerization, reversible addition-fragmentation chain transfer, nitroxide mediated polymerization, cationic polymerization, or an ionic polymerization. In exemplary embodiments, the polymers may be made by radical or controlled radical polymerization methods. Suitable reaction media include but are not restricted to water solution, aqueous solution (comprising water and polarity changing water soluble organic compounds such as alcohols ethers, esters, ketones and or hydroxy ethers), emulsion, and microemulsion.

In exemplary embodiments, the polymerization method used to prepare the polymer is one that allows the polymer to grow to a sufficiently high molecular weight.

In one embodiment, the polymer may be prepared using emulsion polymerization or inverse emulsion polymerization. Those of ordinary skill in the art, with the benefit of this disclosure, will recognize an appropriate polymerization method to synthesize the inventive friction reducing polymer. The present embodiments are not limited by the polymerization method used to synthesize the friction reducing polymers of the present embodiments so long as the method yields the desired friction reducing polymer.

In exemplary embodiments, the polymers may be provided in any suitable form, including in a solid form, suspended in an oil-external, or water-in-oil, polymer emulsion, or as a component of an aqueous solution.

In exemplary embodiments, emulsion polymerization may be used to prepare a suitable emulsion that comprises a friction reducing polymer of the present embodiments. Suitable emulsion polymerization techniques may have a variety of different initiation temperatures depending on, among other things, the amount and type of initiator used, the amount and type of monomers used, the amount and type of inhibitor used, and a number of other factors known to those of ordinary skill in the art. In one embodiment, a suitable emulsion polymerization technique may have an initiation temperature of about 25° C. Due to the exothermic nature of the polymerization reaction, the mixture may be maintained at a higher temperature than the initiation temperature during procession of the polymerization reaction, for example, in the range of from about 30° C. to about 70° C., or from about 40° C. to about 60° C.

Treatment Fluid

In exemplary embodiments, a treatment fluid, for example a well treatment fluid, may comprise the friction reducing polymers described herein and water. In exemplary embodiments, the treatment fluid can be used in any operation where friction reduction is desired including but not limited to stimulation and completion operations, for example hydraulic fracturing applications.

In exemplary embodiments, a method for reducing friction in a well treatment fluid comprises adding to the well treatment fluid a friction reducing polymer comprising two or more recurring units wherein at least one recurring unit is an acrylic acid or acrylamide monomer and at least one recurring unit is a vinyl monomer selected from a vinyl alcohol, a vinyl ester, and a vinyl ether.

In exemplary embodiments, the well treatment fluid is utilized in, or is a component of a process for obtaining hydrocarbons from a subterranean well. In exemplary embodiments, the process is stimulating hydrocarbon production from a subterranean zone penetrated by a well bore. In exemplary embodiments, the process is hydraulic fracturing. In exemplary embodiments, the process is sea water injection.

In exemplary embodiments, the polymers can be included in the stimulation fluids or aqueous treatment fluids in an amount sufficient to provide the desired reduction of friction. In some embodiments, the polymer may be present in an amount in the range of from about 0.1 to about 40 Gallons Per Thousand Gallons of the aqueous treatment fluid (GPTG). In some embodiments, the polymer may be present in an amount in the range of from about 0.25 to about 2.5 GPTG of the aqueous treatment fluid.

In exemplary embodiments, the polymers can be added to slick water treatments at concentrations of 0.1 to 40 GPTG of stimulation fluid. In other embodiments, the friction reducing polymer is added at a concentration of 0.25 to about 2.5 GPTG of stimulation fluid.

In these applications, the fracturing fluid, i.e., well treatment fluid, can be configured as a gelled fluid, a foamed gel fluid, acidic fluids, water and potassium chloride treatments, and the like. The fluid is injected at a pressure effective to create one or more fractures in the subterranean formation. Depending on the type of well treatment fluid utilized, various additives may also be added to the fracturing fluid to change the physical properties of the fluid or to serve a certain beneficial function. Optionally, a propping agent such as sand or other hard material is added which serves to keep the fractures open after the fracturing operation. Also, fluid loss agents may be added to partially seal off the more porous sections of the formation so that the fracturing occurs in the less porous strata. Other oilfield additives that may also be added to the fracturing fluid include emulsion breakers, antifoams, scale inhibitors, H₂S and or O₂ scavengers, crosslinking agents, surface tension reducers, breakers, buffers, surfactants and non-emulsifiers, fluorocarbon surfactants, fluid loss additives, foamers, temperature stabilizers, diverting agents, shale and clay stabilizers, paraffin/asphaltene inhibitors, corrosion inhibitors, acids and biocides. For example, an acid may be included in the aqueous treatment fluids, among other things, for a matrix or fracture acidizing treatment. In fracturing embodiments, propping agent may be included in the treatment fluids to prevent the fracture from closing when the hydraulic pressure is released.

Methods of Use

In exemplary embodiments, the polymers and treatment fluids described herein may be used in any subterranean treatment where the reduction of friction is desired. Exemplary subterranean treatments include, but are not limited to, drilling operations, stimulation treatments, and completion operations. Those of ordinary skill in the art, with the benefit of this disclosure, will be able to recognize a suitable subterranean treatment where friction reduction may be desired.

In exemplary embodiments, a method of treating a portion of a subterranean formation is provided, comprising: adding a friction reducing polymer to a treatment fluid; and introducing the treatment fluid into the portion of the subterranean formation; wherein the friction reducing polymer comprises two or more recurring units wherein at least one recurring unit is an acrylic acid or acrylamide monomer and at least one recurring unit is a vinyl monomer selected from a vinyl alcohol, a vinyl ester, and vinyl ether. In some embodiments, the treatment fluid is introduced into the portion of the subterranean formation at a rate and pressure sufficient to create or enhance one or more fractures in the portion of the subterranean formation. The portion of the subterranean formation that the treatment fluid is introduced will vary dependent upon the particular subterranean treatment. For example, the portion of the subterranean formation may be a section of a well bore, for example, in a well bore cleanup operation. In the stimulation embodiments, the portion may be the portion of the subterranean formation to be stimulated.

### EXAMPLES

### Example 1

### Preparation of Exemplary Polymer

Exemplary emulsion polymers were prepared as described below.

The oil phase used for all samples was prepared by dissolving sorbitan monooleate (20.8 g) in paraffin solvent (186.5 g).

The separate aqueous phase for each sample was prepared by mixing acrylamide (53% aqueous solution), acrylic acid (glacial), and vinyl acetate in the ratios described in Table 1 below, along with deionized water (165.0 g), and diethylenetriaminepentaacetic acid (40% solution, 0.6 g). Ammonia (29% aqueous solution) was added to adjust the pH of each of the samples in the range of 6.0-6.5. The aqueous phase was added to the oil phase and homogenized.

Each sample emulsion was added to a 1 liter glass reactor, and sub-surface sparged with nitrogen for 60 min. The polymerization was initiated by injecting t-butyl hydroperoxide (3.0% solution, 0.2 g). Sulfur dioxide gas was supplied continuously while maintaining a nitrogen blanket to control the reaction temperature under 40° C. After the exotherm ceased, the reaction mixture was heated to 50° C. and held for 1.5 h.

Upon the addition of Surfonic L24-7 (ethoxylated fatty primary alcohol-based nonionic surfactant, 31.2 g), the hydrolysis was accomplished by heating the reaction mixture to 50° C. for 30 min in the presence of caustic solution (50% NaOH aqueous solution, 39.3 g) and polyoxyethylene oleyl amine (12.6 g).

TABLE 1
Exemplary polymer samples.

| | Acrylamide | Acrylic Acid | Vinyl Acetate | Hydrolysis degree |
|---|---|---|---|---|
| Sample | (mol %) | (mol %) | (mol %) | (mol %) |
| 1 | 85 | 0 | 15 | 15 |
| 2 | 85 | 0 | 15 | 30 |
| 3 | 85 | 0 | 15 | 15 |
| 4 | 55 | 30 | 15 | 15 |
| 5 | 80 | 5 | 15 | 15 |
| 6 | 80 | 5 | 15 | 15 |

### Example 2

### Friction Reduction Characteristics of Exemplary Polymers

Exemplary samples 1-6 from Example 1, were tested in a friction loop apparatus to characterize their friction reduction performance in tap water and brine.

The friction loop is a laboratory instrument designed to simulate well fracturing flow conditions. Fracturing in the field often requires pumping over 50 barrels per minute through a ˜4.5″ bore which results in a highly turbulent flow (Reynolds number: 500,000 to 5,000,000). Although it is not possible to achieve this kind of flow in the lab, the friction loop designed simulates the field conditions to the maximum known extent (Reynolds number: 120,000). The data generated by this laboratory scale friction loop is accurate and widely accepted by the industry. The main components of the friction loop are: centrifugal pump, magnetic flow meter and a differential pressure transmitter to create and monitor necessary conditions. All pipes and other components are constructed using stainless steel 316L/304L material.

To test the friction reduction property of the polymer, the friction loop reservoir was filled with 20 L of tap water or Marcellus brine (see Table 2 below).

TABLE 2
Water/Brine Contents for Friction Loop Testing.

| | | | | | Hardness | Hardness |
|---|---|---|---|---|---|---|
| Water/ | | | | | (ppm, | (ppm, |
| Brine | Contents | (g) in 20 L | % | pH | Ca²⁺) | CaCO₃) |
| Tap Water | None | None | None | 5.86 | 24-32 | 60-80 |
| Marcellus | NaCl | 2120 | 10.60 | 6.15 | 10556 | 26390 |
| Brine | CaCl₂ | 768.30 | 2.90 | | | |
| | KCl | 680 | 3.40 | | | |
| | FeSO₄ | 11.0 | 0.03 | | | |

This water or brine was then re-circulated through the friction loop at a flow rate of 24 gallons per minute across a five-foot section of half-inch diameter pipe (required to generate the above mentioned Reynolds number). The baseline pressure drop was measured. The polymer was now added (at a measured concentration of 0.5 gallons of polymer per thousand gallons of water/brine or 0.5 GPTG) to the recirculating solution, where it inverted and dissolved. The degree of friction reduction (% FRt) at a given time ‘t’ was calculated from the initial pressure drop ΔPi and the pressure drop at time t, ΔPt using the equation:

$$\% {FR}_{t} = \frac{Δ {P}_{i} - Δ {P}_{t}}{Δ {P}_{i}} \times 100$$

The results of the friction loop testing for exemplary polymer Samples 1-6, are presented in Table 3, below.

TABLE 3
Friction Reduction Characteristics of Exemplary Polymers

| | Friction | Friction |
|---|---|---|
| | Reduction in | Reduction in |
| | Tap Water | Marcellus Brine |
| Sample | (%) | (%) |
| 1 | 64 | 46 |
| 2 | 67 | 55 |
| 3 | 66 | 42 |
| 4 | 61 | — |
| 5 | 67 | 57 |
| 6 | 65 | 54 |

In the preceding specification, various exemplary embodiments have been described. It will, however, be evident that various modifications and changes may be made thereto, and additional embodiments may be implemented, without departing from the broader scope of the exemplary embodiments as set forth in the claims that follow.

What is claimed is:

1. A friction reducing polymer comprising two or more recurring units wherein at least one recurring unit is an acrylic acid or acrylamide monomer and at least one recurring unit is a vinyl monomer selected from a vinyl alcohol, a vinyl ester, and a vinyl ether.

2. The polymer of claim 1, wherein the acrylic acid or acrylamide monomer is selected from acrylic acid and substituted acrylic acids.

3. The polymer of claim 1, wherein the acrylic acid or acrylamide monomer are selected from acrylamide and substituted acrylamides.

4. The polymer of claim 1, wherein the vinyl monomer is a vinyl alcohol.

5. The polymer of claim 1, wherein the vinyl monomer is a vinyl ester.

6. The polymer of claim 1, wherein the polymer is fully or partially hydrolyzed.

7. The polymer of claim 1, wherein the weight average molecular weight of the polymer is in the range of from about 1,000,000 to about 30,000,000 Da.

8. A method for reducing friction-related losses in a well treatment fluid, wherein the method comprises adding to the well treatment fluid a friction reducing polymer comprising two or more recurring units wherein at least one recurring unit is an acrylic acid or acrylamide monomer and at least one recurring unit is a vinyl monomer selected from a vinyl alcohol, a vinyl ester and a vinyl ether.

9. The method of claim 8, wherein the method is utilized in, or is a component of, a process for obtaining hydrocarbons from a subterranean well.

10. The method of claim 9, wherein the process is stimulating hydrocarbon production from a subterranean zone penetrated by a well bore.

11. The method of claim 9, wherein the process is hydraulic fracturing.

12. The method of claim 9, wherein the process is sea water injection.

13. A well treatment fluid comprising the polymer of claim 1 and water.

14. A method of treating a portion of a subterranean formation is provided, comprising:
adding a friction reducing polymer to a treatment fluid; and introducing the treatment fluid into the portion of the subterranean formation;
wherein the friction reducing polymer comprises two or more recurring units, wherein at least one recurring unit is an acrylic acid or acrylamide monomer and at least one recurring unit is a vinyl monomer selected from a vinyl alcohol, a vinyl ester, and a vinyl ether.

15. The method of claim 14, wherein the treatment fluid is introduced into the portion of the subterranean formation at a rate and pressure sufficient to create or enhance one or more fractures in the portion of the subterranean formation.

16. The method of claim 14, wherein the portion of the subterranean formation is a section of a well bore.

17. The method of claim 14, wherein the portion of the subterranean formation is the portion to be stimulated.
